(19) United States
(12) Patent Application Publication
(10) Pub. No.: US 2007/0265773 A1
(43) Pub. Date: Nov. 15, 2007

(54) USER FRIENDLY METHOD OF COMPUTER GENERATING MAPS FOR REGIONAL DELIVERY SERVICES

(76) Inventors: ANDREW D. HATELY, Austin, TX (US); Merle D. Sterling, Austin, TX (US)

Correspondence Address: IBM CORPORATION;INTELLECTUAL PROPERTY LAW, 11400 BURNET ROAD, AUSTIN, TX, 78758, US

(21) Appl. No.: 11/382,282

(22) Filed: May 9, 2006

(51) Int. Cl. G01C 21/00

(52) U.S. Cl. 701/211; 701/200

(57) ABSTRACT

The manager or host of the computer generating mapping method compiles and stores a list of most of the landmarks within the geographic area within which the deliveries are to be made. The new user is prompted to choose from the stored list all of the landmarks with which he is familiar and knows how to reach. This set of user known landmarks is stored in association with the particular user. When a delivery by the user is to be made within the region, a determination is made of the optimum landmark from which the user may proceed to the destination, and a map is generated only from the landmark to the destination. The basic assumption is that the user knows the starting landmark and how to reach it.

### TECHNICAL FIELD

The present invention relates to methods and programs for computer generated maps, and particularly to such methods that are easy to use by even novice users who use such maps in the delivery of goods and services.

### BACKGROUND OF RELATED ART

The explosive development of the Internet or World Wide Web (Web) has had a major, and still expanding, impact on the consumer purchasing and shopping functions of our society. This has resulted in the rapidly increasing purchase of products over the Internet. Virtually all aspects of shopping and purchasing, e.g. ordering, billing and payment, have been made faster and more efficient by the Internet.

However, there is one function on which the rapid Internet purchasing boom has placed a great burden. All of the purchased products have to be delivered to the ultimate consumer in a timely manner consistent with the speed and efficiency of the other Internet purchasing functions. Conventional delivery carriers such as UPS or FedEx and the US Postal Service have had to deal with this increasing demand for delivery services.

This has created a new work force of less experienced delivery people. Many in this work force work on a part time basis. Many small business delivery services are starting up to meet this demand. The FedEx Corporation, for example, has worked with small business partners in establishing FedEx Home Delivery Services in which small trucking businesses are franchised. Actually, such developments are potentially beneficial to the economy through the creation of new jobs in the delivery business to replace the traditional retail jobs that may be lost to Internet shopping.

These new delivery service functions will be carried out by users inexperienced in the intricacies of destination location using conventional road and street maps, particularly in urban geographical regions. These new delivery functions are likely to operate on tight margins with little tolerance for time wasted in looking for destinations. There is, of course, available to such users, an established variety of computer generated mapping services for locating destinations.

A general survey of available services for generating route maps is described in the article, Rendering Effective Route Maps Improving Usability Through Generalization, by M. Agrawala and C. Stolte, Stanford University, published in Siggraph 2001, and available from the Internet at http://graphics.stanford.edu/papers/routemaps. Also, the operating system WindowsXP™ offers expedients based upon Global Positioning Systems (GPS), as described in the article, Navigate with a Tablet PC and Microsoft Streets & Trips 2005 With GPS Locator, Tony Northrup, April 2005, and available on the Internet at http://www.microsoft.com/windowsxp/using/tablepc/learnmore/n orthrup_navigate.mspx.

While there are many available systems for generating maps to aid in destination location in urban street environments, these would present additional complexities to new delivery drivers.

### SUMMARY OF THE PRESENT INVENTION

The present invention provides an implementation for the computer generation of destination maps that are easy to use and intuitive to the new or novice delivery user by taking advantage of what the user already knows. The manager or host of the computer generating mapping method compiles and stores a list of most of the landmarks within the geographic area within which the deliveries are to be made. The new user is prompted to choose from the stored list, all of the landmarks with which he is familiar, and knows how to reach. This set of user known landmarks is stored in association with the particular user. When a delivery by the user is to be made within the region, a determination is made of the optimum landmark from which the user may proceed to the destination, and a map is generated only from the landmark to the destination. The basic assumption is that the user knows the starting landmark and how to reach it. The optimum landmark is usually the landmark from which the route distance to the destination is shortest. However, other algorithms for selecting the optimum landmark may be used. One alternative would include selecting a departure point, and then determining the minimum route distance from the departure point to the destination via the landmark. Another alternative may involve determining the optimum landmark by a combination of the minimum route distance and the complexity of the routing from the landmark to the destination. In any event, the complexities of optimum landmark selection are unknown and transparent to the user. All he has to do is get to the chosen optimum landmark on his own, and then use the generated map from the landmark to the destination.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a map view of a region in a city within which a delivery man is to deliver, for example, pizzas or packages; this map on a display circles all of the significant landmarks in the region from which the user will be prompted to select a set of these landmarks with which he is familiar;

FIG. 2 is the map of FIG. 1 but only the landmarks in the user selected set are circled;

FIG. 3 is the Map of FIG. 2 but illustrating an alternate embodiment of the invention;

FIG. 4 shows an illustrative delivery map generated using the preferred embodiment of the invention;

FIG. 5 shows an illustrative delivery map generated using an alternate embodiment of the invention;

FIG. 6 is a block diagram of a generalized data processing system including a central processor unit that provides a very general illustration of the computer control system that could be used for the generation of the delivery route maps as used in the present invention;

FIG. 7 is an illustrative flowchart describing the setting up of the elements needed for the program of the invention for the generation of the delivery route maps as used in the present invention; and

FIG. 8 is a flowchart of an illustrative simplified run of the program set up in FIG. 7.

### DETAILED DESCRIPTION OF THE PREFERRED EMBODIMENT

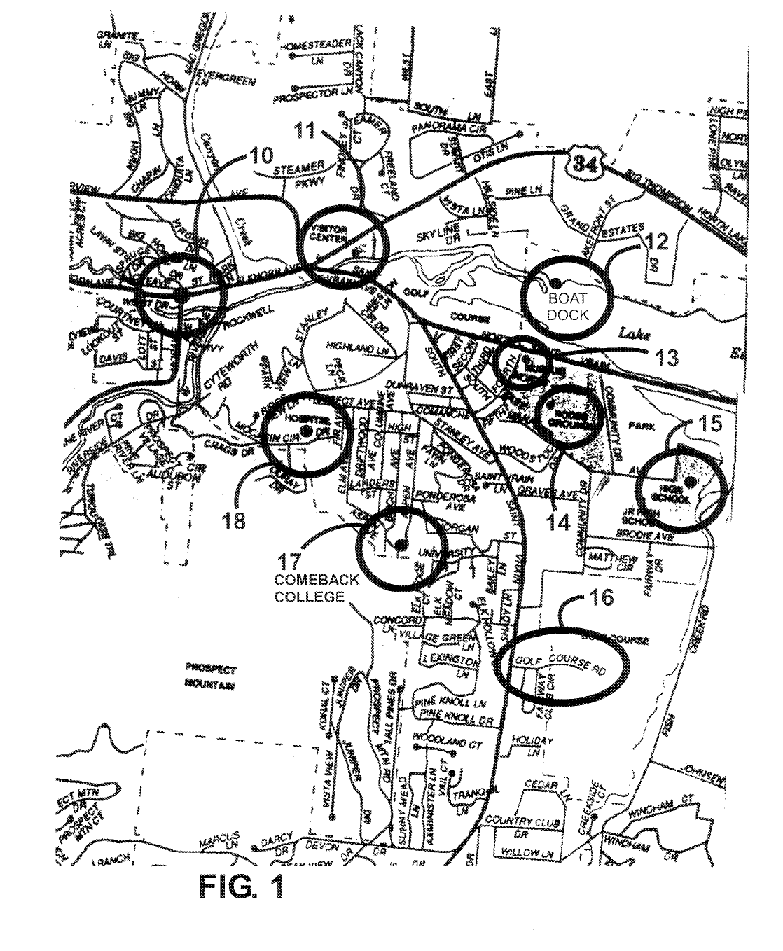

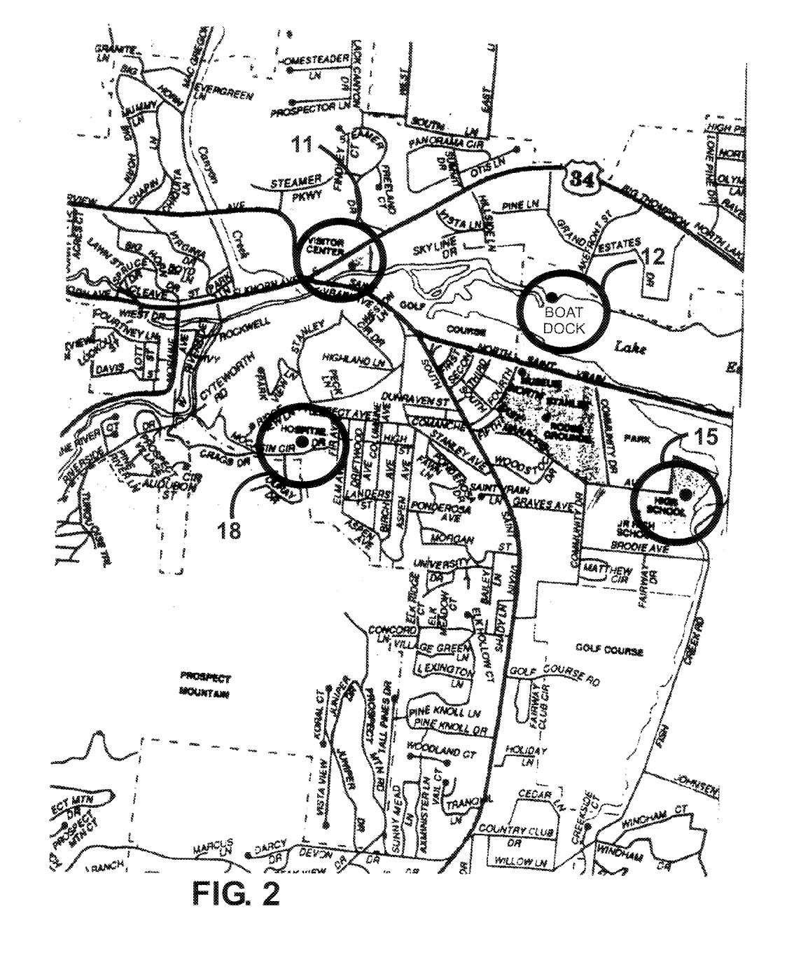

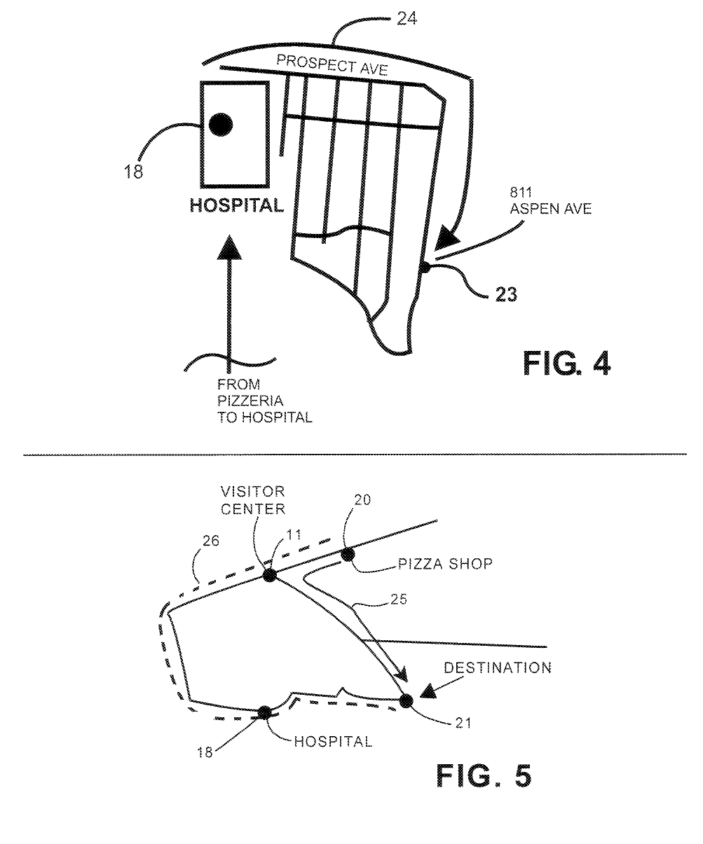

FIG. 1 is a map view of a region in a city within which a delivery person is to deliver, for example, pizzas or packages. This map on a computer controlled display circles or otherwise highlights all of the significant landmarks 10-18 in the region from which the user will be prompted to select a set of the landmarks with which he is familiar. As shown in FIG. 2, the user has selected four landmarks: the visitor center 11, the boat dock 12, the high school 15 and the hospital 18. These four landmarks will be stored as a set for the particular delivery person. Then, as shown in the illustration of FIG. 4, when a call for a delivery to a particular destination is received, the landmark from the stored set for the delivery person closest to this destination is calculated using any of the conventional methods referenced above. The route from only that closest landmark to the destination has to be generated. This will be like the simple map shown in FIG. 4 to destination 23. The map shows the route 24 from the closest or optimum landmark from the delivery persons set, Hospital 18. The route from the starting point, which, in the illustration, is a Pizzeria, need not be shown since the user/delivery person is presumed to know the way to the known landmark 18.

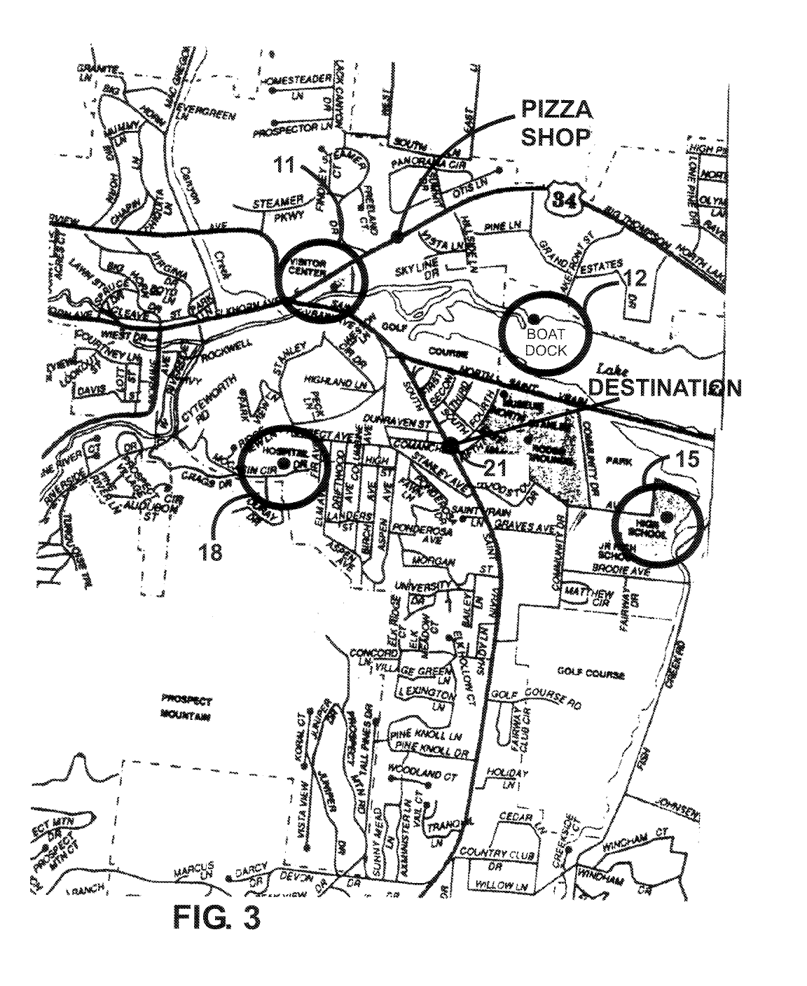

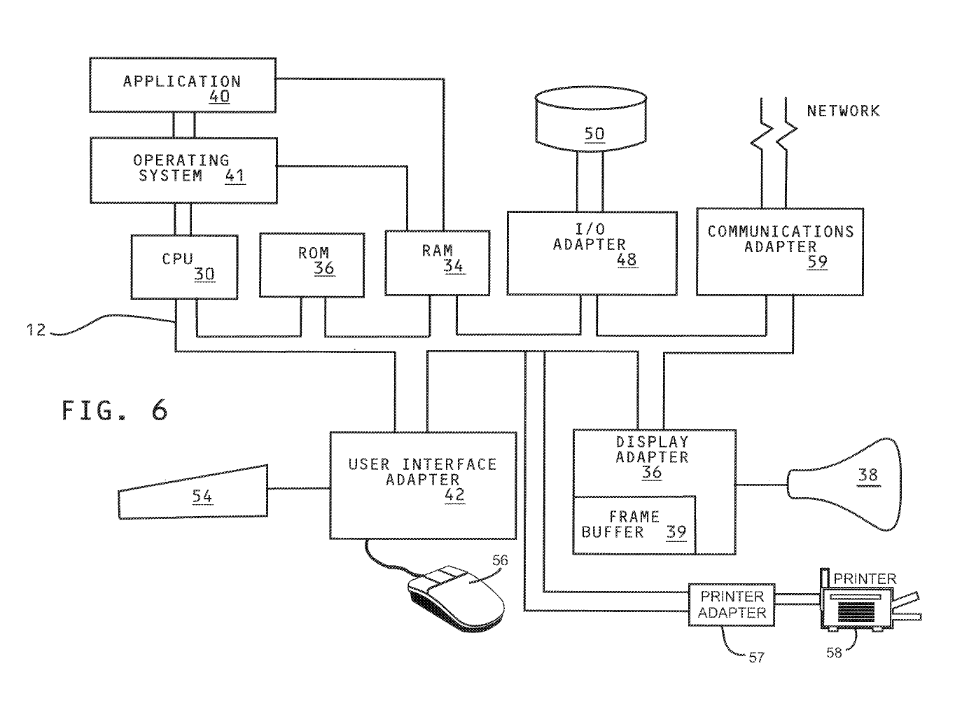

In an alternative embodiment illustrated with respect to FIG. 3, the optimum landmark need not be the landmark closest to the destination. In the situation illustrated in FIG. 3, the closest landmark to the destination 21 is Hospital 18 but the Visitor Center 11 is selected as the optimum landmark. Visitor Center 11 is chosen by an alternate algorithm when it calculates the route that is the minimum distance from the starting point, Pizza Shop 20, via the landmark, Visitor Center 11, to the destination 21. In this embodiment, the calculation is unknown and transparent to the user/driver who, in any event, gets a simple map, even simpler than FIG. 5, showing only the route 25 from the Visitor Center 11 to the destination 21. FIG. 5 also shows that the shorter route shown in dashed lines from Hospital 18 to destination 21 would actually be longer than the chosen route 26, shown in dashed lines from the starting point 20 via landmark 18 to the destination 21.

The optimum landmark for the destination may be chosen by algorithms that weigh the complexity of the route in combination with the shortest distance. For example, the algorithm may take into account weights entered by the system manager for number of turns, number of traffic lights and anticipated traffic densities for different times of the day.

However, irrespective of the method used, all the driver gets is a simplified map from the optimum landmark to the destination. Where the delivery vehicle has a dashboard display, the route may be shown on the display. More likely in a simplified system, the map will be printed out and given to the driven along with his delivery assignment. While the illustration involved a pizza delivery, the invention may be even more effectively used in package delivery by commercial carriers. In such cases, the route may be printed out directly on the delivery bill or invoice.

Referring now to FIG. 6, there is provided a diagrammatic view of an illustrative computer control system that may function to generate the route maps using selected known landmarks in the practice of the present invention. A central processing unit (CPU) 30, such as one of the PC microprocessors or workstations, e.g. RISC System/6000™ series available from International Business Machines Corporation (IBM), or Dell PC microprocessors, is provided and interconnected to various other components by system bus 52. An operating system 41 runs on CPU 30, provides control and is used to coordinate the function of the various components of FIG. 1. Operating system 41 may be one of the commercially available operating systems, such as IBM's AIX 6000™ operating system or Microsoft's WindowsXP™ or Windows2000™, as well as UNIX and other IBM AIX operating systems. Application programs 40, controlled by the system, are moved into and out of the main memory Random Access Memory (RAM) 34. These programs include the programs of the present invention for generating delivery destination maps using optimum landmarks that will be described hereinafter. A Read Only Memory (ROM) 36 is connected to CPU 30 via bus 52 and includes the Basic Input/Output Systems (BIOS) that control the basic computer functions. RAM 34, I/O adapter 48 and communications adapter 59 are also interconnected to system bus 52. I/O adapter 48 may be a Small Computer System Interface (SCSI) adapter that communicates with the disk storage device 50. Communications adapter 59 interconnects bus 52 with the outside Internet or Web network if necessary. I/O devices are also connected to system bus 52 via user interface adapter 42 and display adapter 36. Keyboard 54 and mouse 56 are all interconnected to bus 52 through user interface adapter 42. It is through such input devices that the user may interactively relate to the programs of this invention. The user/delivery person may be prompted to select his set of known landmarks through the display and make his entries via mouse 56. Similarly, the system manager may set up the landmarks and enter any weights needed for the traffic complexity weighted system via display 38 and mouse 56. The generated maps may be output on display 38 or printed by printer 58 connected via printer adapter 57.

Display adapter 36 includes a frame buffer 39 that is a storage device that holds a representation of each pixel on the display screen 38. Images may be stored in frame buffer 39 for display on monitor 38 through various components, such as a digital to analog converter (not shown) and the like. By using the aforementioned I/O devices, a user is capable of inputting information to the system through keyboard 24 or mouse 26 and receiving output information from the system via display 38.

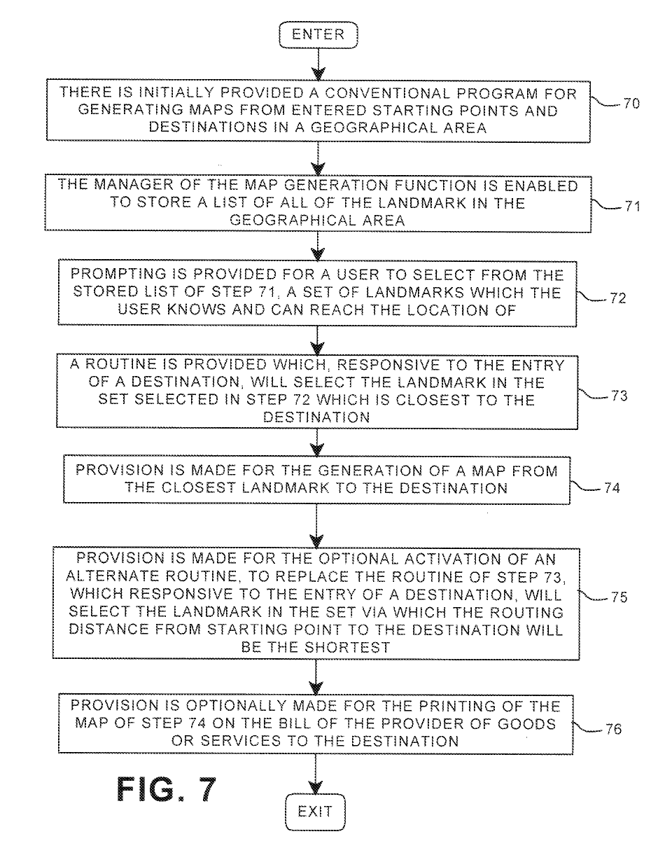

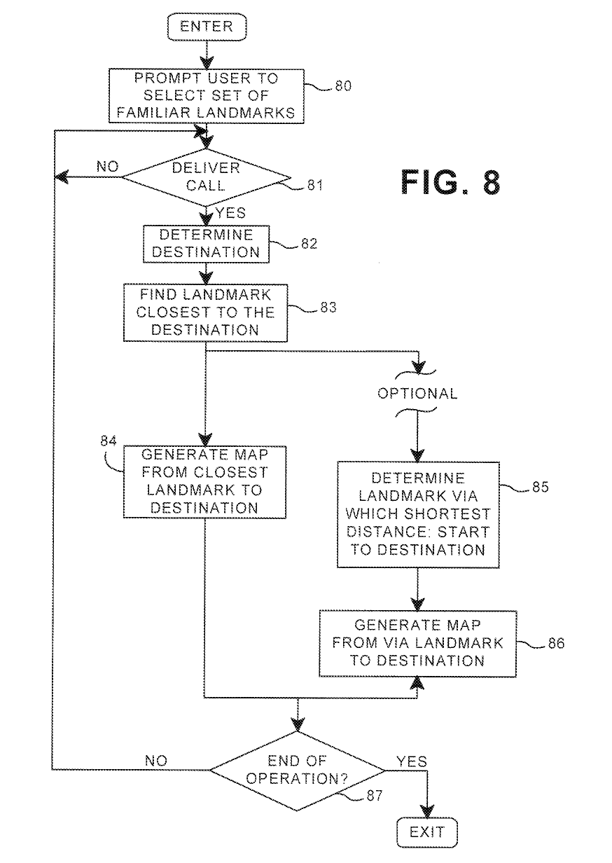

Now, with reference to the programming shown in FIG. 7, there will be described how the system and programs of the present invention are set up. Provided is any suitable conventional program for generating maps from entered starting points in a geographical area or region, step 70. The manager of the Map generating function, usually the manager of the delivery function, is enabled to set up and store a displayable list of all of the landmarks within the geographical area, step 71. A display is provided for prompting a user/delivery person to select via a computer controlled display screen, a subset from the total list stored in step 71 of landmarks that the user knows and can reach the location, step 72. A routine is provided which, responsive to the entry of a destination, will automatically select the landmark from the set selected in step 72 that is closest to the destination, step 73. Provision is made for the generation of a Map showing the route from the closest landmark to the destination, step 74.

Provision is also made for the optional activation of an alternative routine to replace the routine of step 73 that is responsive to the entry of a destination and will select the landmark in the driver's set from which the routing distance from the starting point to the destination will be the shortest, step 75. The system may provide for the printing of the Map of step 74 to the destination on the bill of the provider of goods or services so that the driver may conveniently have the map together with the invoice or shipping bill, step 76.

Now, with reference to the flowchart of FIG. 8, a simplified illustrative run of the process set up in FIG. 7 will be described. The new driver is prompted, as previously described, to select through the interactive display his set of familiar landmarks, step 80. A delivery call is awaited, step 81. If Yes, the destination is determined, step 82, and the landmark from the driver's set closest to the destination is determined, step 83, and a simplified route map is generated from the closest landmark to the destination, step 84. Optionally, as an alternative, a landmark from the driver's set is determined from which the overall distance from the starting location to the destination is shortest, step 85, and a simplified route map is generated from this landmark to the destination, step 86. After a map is generated, step 84 or 86, a determination may conveniently be made as to whether the delivery operation is over, step 87. If Yes, the program is exited. If No, the process is returned to step 81 where the next delivery call is awaited.

It should be noted that the operational principles described hereinabove are applicable if the delivery person is to make a plurality of deliveries on a delivery route. The initial shipping or departure point is still operative to select the first landmark. Then, the first and subsequent destinations receiving a delivery are considered as shipping points in the subsequent determination of optimum landmarks for each subsequent destination.

Although certain preferred embodiments have been shown and described, it will be understood that many changes and modifications may be made therein without departing from the scope and intent of the appended claims.

What is claimed is:

1. A computer controlled method for generating maps for the guidance of users to destinations within a geographical area comprising:
storing the locations of a plurality of landmarks within the geographical area;
prompting the user to select, from said plurality of landmarks, a set of landmarks of known location to the user;
selecting a destination within the geographical area;
determining the optimum landmark in said set of landmarks from which the user may proceed to the selected destination; and
generating a map from said optimum landmark to said selected destination.

2. The method of claim 1 wherein said optimum landmark is determined by the minimum route distance from the landmark to the destination.

3. The method of claim 1 wherein said optimum landmark is determined by the steps of:
selecting a departure point; and
determining the minimum route distance from the departure point to the destination via the landmark.

4. The method of claim 2 wherein said optimum landmark is determined by a combination of the minimum route distance and the complexity of the routing from the landmark to the destination.

5. The method of claim 3 wherein said optimum landmark is determined by a combination of the minimum route distance and the complexity of the routing from the departure point to the destination via the landmark.

6. The method of claim 1 further including the step of enabling the user to dynamically select additional landmarks for said set.

7. The method of claim 1 wherein said user generates maps to guide a plurality of deliveries of goods to destinations within said geographical area.

8. The method of claim 7 further including the step of generating a bill for delivered goods including said generated map.

9. The method of claim 1 wherein said generated map is displayed to the user.

10. The method of claim 1 wherein said generated map is printed for the user.

11. A computer program having code recorded on a computer readable medium for generating maps for the guidance of users to destinations within a geographical area comprising:
means for storing the locations of a plurality of landmarks within the geographical area;
means for prompting the user to select, from said plurality of landmarks, a set of landmarks of known location to the user;
means for selecting a destination within the geographical area;
means for determining the optimum landmark in said set of landmarks from which the user may proceed to the selected destination; and
generating a map from said optimum landmark to said selected destination.

12. The computer program of claim 11 wherein said optimum landmark is determined by the minimum route distance from the landmark to the destination.

13. The computer program of claim 11 wherein said means for determining the optimum landmark includes:
means for selecting a departure point; and
means for determining the minimum route distance from the departure point to the destination via the landmark.

14. The computer program of claim 12 wherein said means for determining the optimum landmark includes means for correlating the minimum route distance and the complexity of the routing from the landmark to the destination.

15. The computer program of claim 13 wherein said means for determining the optimum landmark includes means for correlating the minimum route distance and the complexity of the route from the landmark to the destination.

16. The computer program of claim 11 further including means for enabling the user to dynamically select additional landmarks for said set.

17. The computer program of claim 11 wherein said user generates maps to guide a plurality of deliveries to destinations within said geographical area.

18. The computer program of claim 17 further including means for generating a bill for delivered goods including said generated map.

19. The computer program of claim 11 wherein said generated map is displayed to the user.

20. The computer program of claim 11 wherein said generated map is printed for the user.
